(19) United States
(12) Patent Application Publication
(10) Pub. No.: US 2010/0115619 A1
(43) Pub. Date: May 6, 2010

(54) METHOD AND SYSTEM FOR SCANNING A COMPUTER STORAGE DEVICE FOR MALWARE INCORPORATING PREDICTIVE PREFETCHING OF DATA

(76) Inventor: Michael Burtscher, Broomfield, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/263,652

(22) Filed: Nov. 3, 2008

(51) Int. Cl. G06F 11/00; G06F 7/00

(52) U.S. Cl. 726/24

(57) ABSTRACT

A method and system for scanning a computer storage device for malware is described. One embodiment keeps track of which portion or portions of each of a plurality of files on a computer storage device are requested for analysis by an anti-malware engine during a first scan of the computer storage device for malware; prefetches, during a second scan of the computer storage device for malware, the portion or portions of each of at least a subset of the plurality of files that were requested by the anti-malware engine during the first scan, the prefetched data being supplied to the anti-malware engine for analysis as requested; and takes corrective action responsive to the results of at least one of the first and second scans.

### RELATED APPLICATIONS

The present application is related to the following commonly owned and assigned U.S. patent applications: application Ser. No. 11/104,201, entitled “System and Method for Accessing Data from a Data Storage Medium,” now issued U.S. Pat. No. 7,346,611; and application Ser. No. 11/104,202, entitled “System and Method for Directly Accessing Data from a Data Storage Medium”; each of which is incorporated herein by reference.

### FIELD OF THE INVENTION

The present invention relates generally to digital computers. More specifically, but not by way of limitation, the present invention relates to methods and systems for scanning a computer storage device for malware.

### BACKGROUND OF THE INVENTION

Scanning a computer storage device such as a hard disk drive to detect malware (e.g., viruses, Trojan horses, worms, spyware, adware, keyloggers) can become challenging nowadays because such storage devices have become very large (hundreds of gigabytes), and users rarely delete the files they create. The result is that it can take a long time to scan an entire storage volume, discouraging users from scanning for malware as frequently as they should.

In scanning a storage device for malware, one generally cannot rely on the operating system alone to locate and access files because some types of malware hide themselves from the operating system. Accessing a large number files in the standard way via the operating system's Application Program Interface (API) is also time consuming. Techniques such as direct disk access (DDA) can be used to speed up a malware scan to some extent, but conventional solutions, even those employing DDA, do not cope sufficiently well with all of the difficulties that can arise in scanning a large storage volume.

It is thus apparent that there is a need in the art for an improved method and system for scanning a computer storage device for malware.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for scanning a computer storage device for malware. One illustrative embodiment is a method for scanning a computer storage device for malware, the computer storage device including a plurality of files, the method comprising (1) performing the following for each file in the plurality of files during a first scan of the computer storage device to detect malware: receiving a request from an anti-malware engine for one or more portions of the file; reading from the computer storage device the one or more portions of the file requested by the anti-malware engine and supplying them to the anti-malware engine, the anti-malware engine analyzing the one or more portions of the file for malware; and recording which one or more portions of the file were requested for analysis by the anti-malware engine; (2) performing the following for each of at least a subset of the plurality of files during a second scan of the computer storage device to detect malware: prefetching into a buffer the one or more portions of the file requested for analysis by the anti-malware engine during the first scan; and supplying to the anti-malware engine the prefetched one or more portions of the file as they are requested, the anti-malware engine analyzing the prefetched one or more portions of the file for malware; and (3) taking corrective action responsive to results of at least one of the first and second scans of the computer storage device to detect malware.

Another illustrative embodiment is a computer system, comprising at least one processor; a storage device including a plurality of files; and a memory containing a plurality of program instructions; wherein the plurality of program instructions are configured to cause the at least one processor, for each file in the plurality of files during a first scan of the storage device to detect malware, to receive a request for one or more portions of the file from an anti-malware engine of the computer system; read from the storage device the one or more portions of the file requested by the anti-malware engine and to supply them to the anti-malware engine, the anti-malware engine analyzing the one or more portions of the file for malware; and record which one or more portions of the file were requested for analysis by the anti-malware engine; wherein the plurality of program instructions are configured to cause the at least one processor, for each of at least a subset of the plurality of files during a second scan of the storage device to detect malware, to prefetch into a buffer the one or more portions of the file requested for analysis by the anti-malware engine during the first scan; and supply to the anti-malware engine the prefetched one or more portions of the file as they are requested, the anti-malware engine analyzing the prefetched one or more portions of the file for malware; and wherein the plurality of program instructions are configured to cause the at least one processor to take corrective action responsive to results of at least one of the first and second scans of the storage device for malware.

The methods of the invention can also be embodied, at least in part, as a plurality of program instructions executable by a processor that are stored on a computer-readable storage medium.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying drawings, wherein:

FIG. 1 is a functional block diagram of a computer system in accordance with an illustrative embodiment of the invention;

FIGS. 2A-2C are a flowchart of a method for scanning a computer storage device for malware in accordance with an illustrative embodiment of the invention; and

FIGS. 3A and 3B are comparative diagrams illustrating the operation of an illustrative embodiment of the invention.

### DETAILED DESCRIPTION

In some implementations, a malware scanning application makes one efficient pass over a computer storage device without jumping ahead or backtracking. This is particularly desirable if the storage device is a hard disk drive because disk seeks are time consuming. Such an efficient one-pass approach is possible if the data to be analyzed from each file is predictable (e.g., the first 500 bytes of each file) and the files are scanned in accordance with the order in which they physically appear on the storage device.

In other implementations, however, a malware scanning application may make use of a third-party anti-malware engine (e.g., a collection of malware definitions and the supporting logic that applies them to the data being scanned) that is somewhat separate from the rest of the malware scanning application. In such an implementation, the malware scanning application typically reads the storage device to supply the anti-malware engine with particular portions of the respective files on the storage device that the anti-malware engine requests and analyzes.

One difficulty that arises in such implementations is that the malware scanning application does not know in advance what portions of a given file the third-party anti-malware engine will request. For example, the anti-malware engine might request the first 64 KB and the last ten bytes of a particular file. On a hard disk drive, such a split request, multiplied by many files, can result in numerous costly disk seeks. Also, a scanning algorithm in which a particular amount of data is read from the beginning of each file can result in wasted time and buffer space if the anti-malware engine ultimately requests a smaller portion of a file than was actually read. The fragmentation of files on a storage device further complicates the process of scanning for malware.

The above problems can be overcome through the exploitation of a couple of observations, culminating in various illustrative embodiments of the invention. First, it has been observed that the vast majority of files on a storage device do not change over time. Some files are added and some are deleted over time, but most files (e.g., operating-system files, applications, and many user-created documents) do not change. That is, about 99 percent of the files on a typical storage device are static.

Second, if the malware definitions and the particular scanning algorithm have not changed, a given unchanged file is normally scanned and analyzed in the same way each time with the same result (“malware” or “not malware”). That is, the results of scanning and analyzing for malware are substantially predictable and repeatable for a given file. The most common types of changes (e.g., updates) that occur in malware definitions generally do not change which portions of the files need to be scanned-and that are requested by the anti-malware engine. For example, even if a checksum for a particular portion of a particular malware file changes in the corresponding malware definition, the same portion of the file is still read to compute the checksum.

In various illustrative embodiments of the invention, the specific portions of the respective files on a storage device that are requested for analysis by an anti-malware engine (in some embodiments, a third-party anti-malware engine) are tracked on a file-by-file basis as the storage device is scanned for malware. When the same storage device is subsequently scanned for malware, the portions of the respective files requested during the previous scan are prefetched into a buffer so that they can be supplied to the anti-malware engine in an efficient manner that both reduces disk seeks and avoids the reading of unnecessary data.

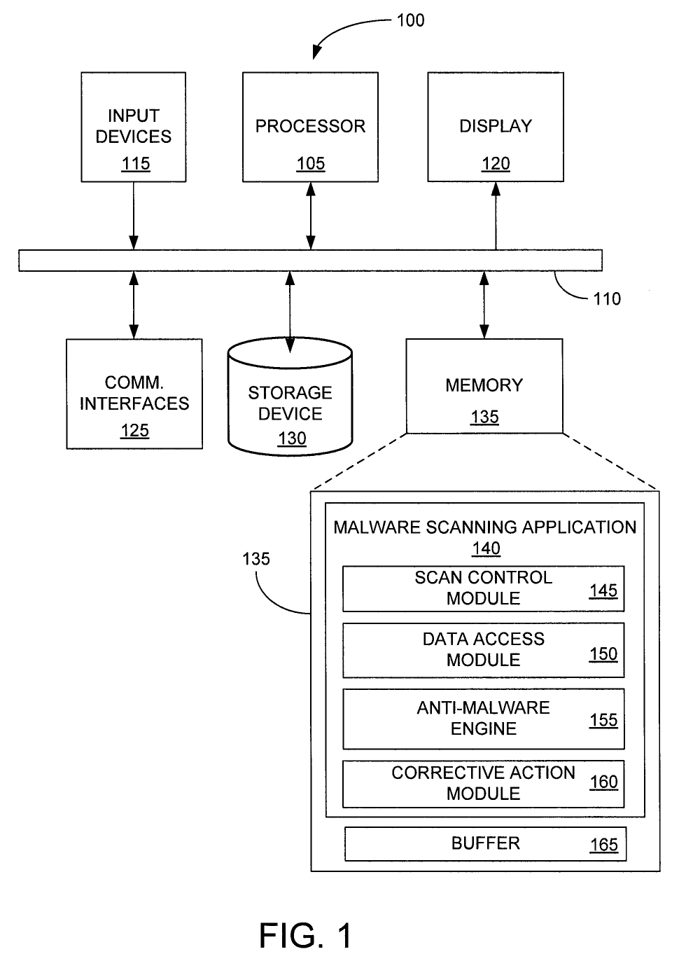

Referring now to the drawings, where like or similar elements are designated with identical reference numerals throughout the several views, and referring in particular to FIG. 1, it is a functional block diagram of a computer system 100 in accordance with an illustrative embodiment of the invention. In FIG. 1, processor 105 communicates over data bus 110 with input devices 115, display 120, communication interfaces 125, storage device 130, and memory 135. Though FIG. 1 shows only a single processor, multiple processors or a multi-core processor may be present in some embodiments.

Input devices 115 include, for example, a keyboard, a mouse or other pointing device, or other devices that are used to input data or commands to computer system 100 to control its operation. Communication interfaces 125 (“COMM. INTERFACES” in FIG. 1) may include, for example, various serial or parallel interfaces for communicating with a network or one or more peripherals.

Storage device 130 stores one or more files (not shown in FIG. 1) in accordance with a file system associated with the operating system of computer system 100. Storage device 130 may be, for example, a hard disk drive (HDD), a flash-memory-based storage device, or other computer data storage device, depending on the particular embodiment. In general, storage device 130 provides nonvolatile storage of programs, system files, and user documents and data.

Memory 135 may include, without limitation, random access memory (RAM), read-only memory (ROM), flash memory, magnetic storage (e.g., a hard disk drive), optical storage, or a combination of these, depending on the particular embodiment.

In FIG. 1, memory 135 includes malware scanning application 140, which includes the following functional modules: scan control module 145, data access module 150, anti-malware engine 155, and corrective action module 160. The division of malware scanning application 140 into the particular functional modules shown in FIG. 1 is merely illustrative. In other embodiments, the functionality of these modules may be subdivided or combined in ways other than that indicated in FIG. 1.

In the illustrative embodiment of FIG. 1, malware scanning application 140 scans memory 135 (e.g., process memory) and one or more storage devices such as storage device 130 to detect and remove malware. In the discussion of various illustrative embodiments of the invention that follows, the focus will be on the scanning of a storage device such as storage device 130 rather than on the scanning of process memory. In one illustrative embodiment, malware scanning application 140 and its functional modules shown in FIG. 1 are implemented as software that is executed by processor 105. Such software may be stored, prior to its being loaded into RAM for execution by processor 105, on any suitable computer-readable storage medium such as a hard disk drive, an optical disk, or a flash memory (see storage device 130). In general, the functionality of malware scanning application 140 may be implemented as software, firmware, hardware, or any combination or sub-combination thereof.

Scan control module 145 controls the overall process of scanning a storage device such as storage device 130 to detect and deal with malware. That is, scan control module 145 implements a predetermined scanning algorithm. Data access module 150 handles the reading of data for analysis from a storage device such as storage device 130 under the direction of scan control module 145.

Anti-malware engine 155 analyzes one or one or more portions of each file scanned on storage device 130 to detect the presence of malware. In performing its analysis, anti-malware engine 155 may employ a collection of malware signatures or definitions-characteristic patterns that identify particular types of malware. In some embodiments, the malware definitions are stored in the form of MD5 hash values for rapid and efficient comparison with MD5 hash values of target data being analyzed. Herein, “malware” includes, without limitation, viruses, Trojan horses (or trojans), worms, spyware, adware, and keyloggers. During a scan of storage device 130, anti-malware engine 155 requests one or more specific portions of each scanned file for analysis. Data access module 150 reads the requested one or more portions of each scanned file from storage device 130 and provides them to anti-malware engine 155 for analysis.

In some embodiments, data access module 150 uses direct disk access (also called direct drive access) (DDA) to more efficiently and rapidly access the data to be analyzed for malware. As those skilled in the art are aware, DDA, sometimes called “raw I/O,” is a method of accessing a storage device in which the standard file Application Programming Interface (API) function calls of the operating system are bypassed.

In some embodiments, anti-malware engine 155 is supplied to the maker of malware scanning application 140 by a third party. In such embodiments, data access module 150 does not know in advance which portion or portions of the respective files anti-malware engine 155 will request. However, data access module 150 records (keeps track of), on a file-by-file basis, which one or more portions each file are requested for analysis by anti-malware engine 155 during a malware scan. On a subsequent scan, data access module 150 uses this information to prefetch the relevant portions of each file into buffer 165. Further, data access module can prefetch the needed data in an order that minimizes disk seeks (where storage device 130 is a HDD), speeding up the subsequent malware scan significantly.

Depending on the particular embodiment, new files added to storage device 130 between one scan and a the next scan can be scanned in the same manner as during the earlier scan. Changed files can either be treated as new files, or they can be scanned using the prefetch information from the previous scan for those portions of the files that are unchanged relative to the previous scan. For example, a file may be changed in a manner that renders a large percentage of the previous prefetch data still valid.

Corrective action module 160 is configured to take appropriate corrective action in response to the results of a malware scan, in particular to a determination that one or more files on storage device 130 are or include malware. Corrective action can include, for example, reporting the results of the scan to a user (whether or not any malware was detected on storage device 130), quarantining one or more infected files, removing (deleting) the infected files, or a combination or sub-combination of these actions. Reporting can be accomplished, for example, by displaying the report on display 120, writing to a log file, or both.

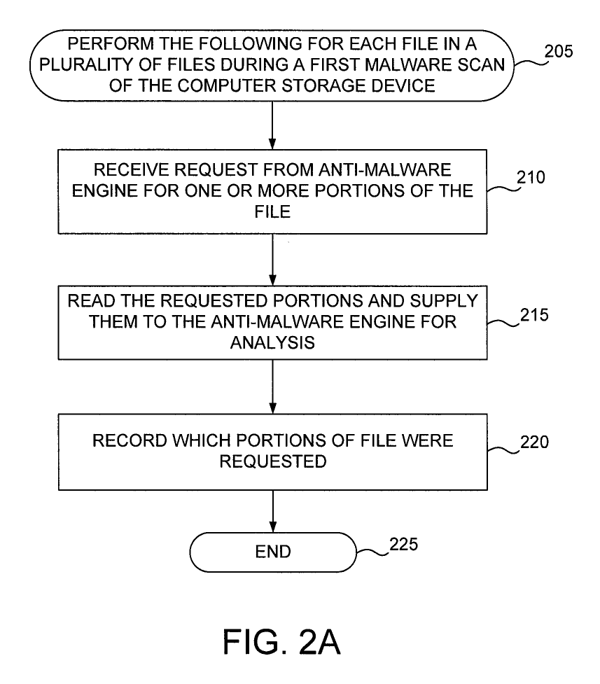

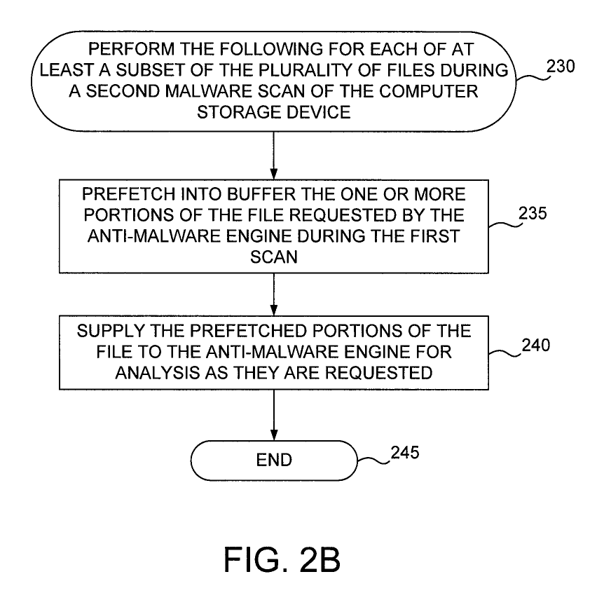

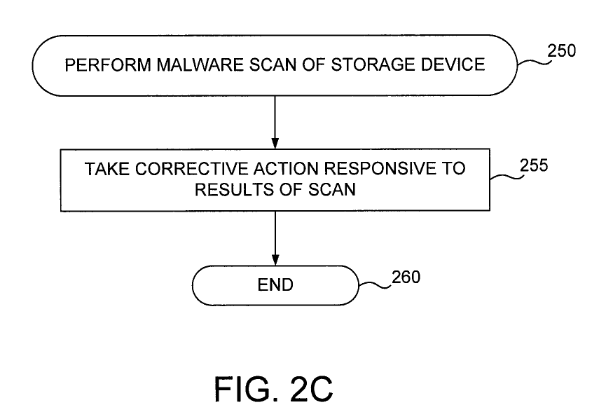

FIGS. 2A-2C are a flowchart of a method for scanning a computer storage device for malware in accordance with an illustrative embodiment of the invention. Referring first to FIG. 2A, the method begins at 205. The actions shown in Blocks 210, 215, and 220 are performed by malware scanning application 140 for each file in a plurality of files on storage device 130 during a first scan of storage device 130 for malware. Herein, “first scan” simply refers to a scan that is earlier in time than a “second scan” discussed below. “First scan,” in this context does not necessarily refer to the very first time malware scanning application 140 scans a particular storage device 130. That is, the “first scan” referred to here could be the tenth scan of storage device 130 by malware scanning application 140 since the installation of malware scanning application 140, and the “second scan” discussed below could be the eleventh such scan. In other words, the terms “first scan” and “second scan” refer to an arbitrary pair of scans, the first simply occurring earlier in time than the second.

At 210, data access module 150 receives a request from anti-malware engine 155 for one or more portions of the current file being scanned. Note that, in some embodiments, data access module 150 may be configured to read a predetermined amount from each file (e.g., 64 KB for documents and 4 MB for executable files) and to buffer that data proactively. Anti-malware engine 155 may, however, request additional or different portions of the file for analysis.

At 215, data access module reads the portion or portions of the file requested at 210 (any not already read) into buffer 165. Those portions in buffer 165 are then supplied to anti-malware engine 155 for analysis. During this first malware scan, data access module 150 records which portions of the file were requested for analysis by anti-malware engine 155. That is, the data from the file that was actually analyzed is noted for future reference. Such information may be stored in a look up table or other suitable data structure. At 225, the first-scan phase of the method terminates.

Referring next to FIG. 2B, this portion of the method begins at 230. The actions shown in Blocks 235 and 240 are performed for each of at least a subset of the plurality of files scanned during the first malware scan during a second, later scan of storage device 130.

At 235, data access module 150 prefetches into buffer 165 the one or more portions of the file requested by anti-malware engine 155 during the first (previous) scan (see Block 210 in FIG. 2A). At 240, data access module supplies, to anti-malware engine 155, the prefetched one or more portions of the file as they are requested by anti-malware engine 155 so that anti-malware engine 155 can analyze the data for malware. The second-scan phase of the method terminates at 245.

As noted above, data access module 150 can attempt to minimize the disk seeks associated with predictively prefetching the one or more portions of a file needed for analysis by prefetching the data in a particular order (e.g., the order in which the needed portions of the respective files physically appear on storage device 130). In some embodiments, it is possible for data access module 150 to prefetch all of the data in one unidirectional pass over storage device 130. In other embodiments, data access module prefetches as much of the needed data as is feasible during a first pass over storage device 130 and then makes additional passes to pick up the rest of the data to be prefetched.

Finding an optimum solution for prefetching that minimizes disk seeks becomes complex for a finite buffer 165. A truly optimum solution would require consideration of disk speed, seek time, available buffer memory, and the specific manner in which the files are fragmented. In a practical finite-buffer implementation, one challenge that arises is that a file might include two fragments that are widely separated physically on storage device 130. One must decide, for example, whether to hold the first fragment in buffer 165 until the other is reached. If the decision is made not to read the first fragment at that time, the second fragment is automatically skipped until a subsequent pass over storage device 130 (there is no point in reading the second fragment without the first if both are needed by anti-malware engine 155). Thus, the decision boils down to “read now” or “read later.” Of course, each such decision affects what would be “optimum” for a particular malware scan.

In one embodiment, data access module 150 attempts to make the best “locally optimum” decision of whether to “read now” or “read later” for each file as it is scanned. Such a locally optimum decision can be based, for example, on how many files are already in buffer 165, how many files remain to be scanned on storage device 130, or other relevant factors.

During a subsequent malware scan such as that shown in FIG. 2B, data access module records which portion or portions of any new files added since the earlier scan are requested for analysis by anti-malware engine 155 during the second scan. During a third scan (not shown in FIGS. 2A-2C), that information can be used to prefetch the needed analysis data for the new files added between the two prior scans.

Referring next to FIG. 2C, this portion of the method can be performed during or following any malware scan (see Block 250) such as the first and second scans discussed in connection with FIGS. 2A and 2B, respectively. At 255, corrective action module 160 takes corrective action responsive to the results of the malware scan, as discussed above. Even if anti-malware engine 155 detects no malware on storage device 130, corrective action module 160 is configured, in some embodiments, to report the absence of malware to a user or administrator. At 260, the method terminates.

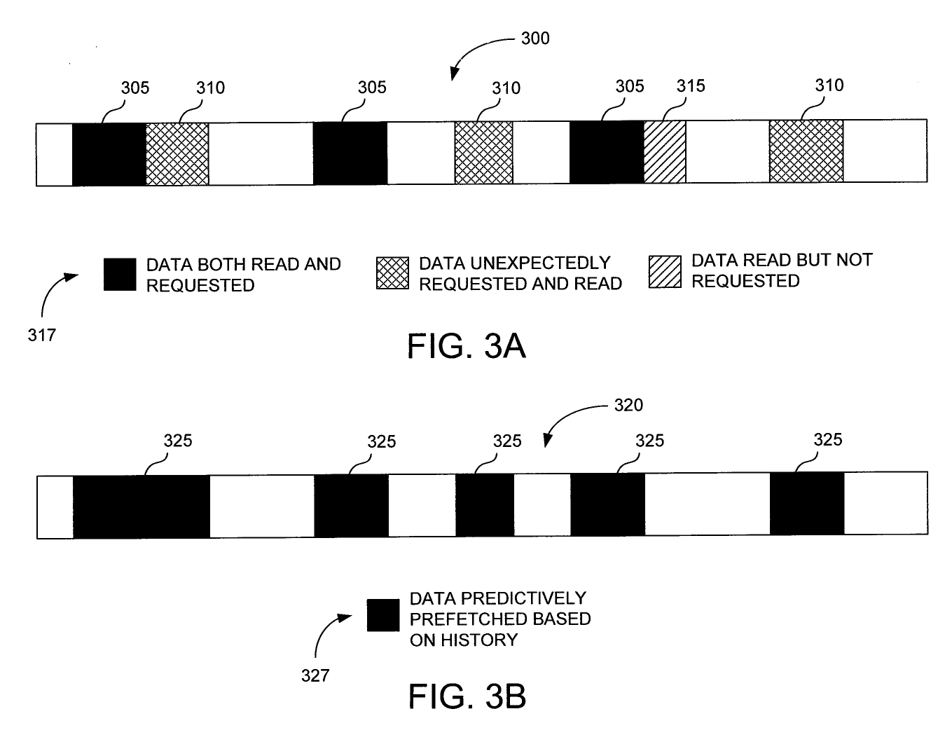

FIGS. 3A and 3B are comparative diagrams illustrating the operation of an illustrative embodiment of the invention. Referring first to FIG. 3A, it is a diagram depicting data 300 on storage device 130, the marked portions of which are read during a malware scan such as the first scan discussed in connection with FIG. 2A (i.e., a scan in which data access module 150 lacks prior knowledge of exactly which portions of a given file on storage device 130 anti-malware engine 155 will request for analysis). One purpose of FIG. 3A is to demonstrate what happens when the techniques of predictive prefetching discussed above are not available to malware scanning application 140.

In FIG. 3A, portions of data 300 are marked, in accordance with legend 317, as “data both read and requested” (305), “data unexpectedly requested and read” (310), and “data read but not requested” (315). The portions 305 represent those read by data access module 150 (proactively, prior to a request from anti-malware module 155, in this particular embodiment) that are ultimately also requested by anti-malware engine 155. The portions 310 represent costly (in terms of time) disk reads/seeks. The portions 310 are those that data access module 150 does not expect to read but that anti-malware engine 155 nevertheless requests during the scan, forcing data access module to backtrack or skip ahead on storage device 130 to read them. The portions 315 (only one of which is shown in the particular example of FIG. 3A) represent data read by data access module 150 but ultimately not requested (and, hence, not analyzed) by anti-malware engine 155.

Referring next to FIG. 3B, it is a diagram depicting data 320 on storage device 130, the marked portions of which (see legend 327) are read during a malware scan of storage device 130 subsequent to that discussed above in connection with FIG. 3A. In this case, data access module 150 has access to stored information about which portion or portions of each scanned file on storage device 130 were requested and analyzed by anti-malware engine 155 during the prior malware scan, as explained above. In this example, there are no costly reads/seeks (see 310 in FIG. 3A), and there is no wasted data (see 315 in FIG. 3A).

The predictive prefetching techniques described above work well for the vast majority (e.g., 99 percent for some users) of files on storage device 130 that do not change from malware scan to malware scan. Updates (additions or alterations) to the malware definitions employed by anti-malware engine 155 and the addition of new files to storage device 130 can require some additional overhead, but the prefetching techniques described above still significantly improve the performance of malware scanning. Once reason is that only what is actually needed for analysis gets read from storage device 130. For example, some embodiments of the invention are estimated to speed up a typical malware scan of a large storage device 130 by approximately a factor of five.

In one illustrative embodiment of the invention, the methods of the invention are implemented, at least in part, as a plurality of program instructions executable by a processor and stored on a computer-readable storage medium such as, without limitation, a hard disk drive (HDD), optical disc, ROM, or flash memory. In such an embodiment, the various functional units such as scan control module 145, data access module 150, anti-malware engine 155, and corrective action module 160 can be implemented as one or more instruction segments (e.g., functions or subroutines).

The principles of the invention can be generalized and applied in settings other than malware detection. In fact, the predictive prefetching techniques discussed above can be used to improve the performance of any application that requests specific data from another process in a substantially repeatable (predictable) manner. Even if the manner in which the application requests data is not perfectly repeatable/predictable, performance improvements can still be realized using the techniques described herein to the extent that the application's data requests are repeatable/predictable. In one illustrative embodiment, the invention is embodied as a software plug-in that can be supplied to another entity that produces such an application.

In conclusion, the present invention provides, among other things, a method and system for scanning a computer storage device for malware. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for scanning a computer storage device for malware, the computer storage device including a plurality of files, the method comprising:
performing the following for each file in the plurality of files during a first scan of the computer storage device to detect malware:
receiving a request from an anti-malware engine for one or more portions of the file;
reading from the computer storage device the one or more portions of the file requested by the anti-malware engine and supplying them to the anti-malware engine, the anti-malware engine analyzing the one or more portions of the file for malware; and
recording which one or more portions of the file were requested for analysis by the anti-malware engine;
performing the following for each of at least a subset of the plurality of files during a second scan of the computer storage device to detect malware:
prefetching into a buffer the one or more portions of the file requested for analysis by the anti-malware engine during the first scan; and
supplying to the anti-malware engine the prefetched one or more portions of the file as they are requested, the anti-malware engine analyzing the prefetched one or more portions of the file for malware; and
taking corrective action responsive to results of at least one of the first and second scans of the computer storage device to detect malware.

2. The method of claim 1, wherein the portions of a file requested by the anti-malware engine for analysis during the first scan are not contiguous.

3. The method of claim 1, wherein the anti-malware engine is configured to detect at least one of spyware, adware, viruses, Trojan horses, worms, and keyloggers.

4. The method of claim 1, wherein the computer storage device is a hard disk drive.

5. The method of claim 4, wherein the respective one or more portions of the files in the at least a subset of the plurality of files are prefetched in an order that reduces seeks on the hard disk drive.

6. The method of claim 4, wherein the reading and the prefetching include use of direct disk access.

7. The method of claim 1, wherein taking corrective action includes reporting the results to a user.

8. The method of claim 1, wherein taking corrective action includes at least one of quarantining and removing malware detected on the computer storage device.

9. A computer system, comprising:
at least one processor;
a storage device including a plurality of files; and
a memory containing a plurality of program instructions;
wherein the plurality of program instructions are configured to cause the at least one processor, for each file in the plurality of files during a first scan of the storage device to detect malware, to:
receive a request for one or more portions of the file from an anti-malware engine of the computer system;
read from the storage device the one or more portions of the file requested by the anti-malware engine and to supply them to the anti-malware engine, the anti-malware engine analyzing the one or more portions of the file for malware; and
record which one or more portions of the file were requested for analysis by the anti-malware engine;
wherein the plurality of program instructions are configured to cause the at least one processor, for each of at least a subset of the plurality of files during a second scan of the storage device to detect malware, to:
prefetch into a buffer the one or more portions of the file requested for analysis by the anti-malware engine during the first scan; and
supply to the anti-malware engine the prefetched one or more portions of the file as they are requested, the anti-malware engine analyzing the prefetched one or more portions of the file for malware; and
wherein the plurality of program instructions are configured to cause the at least one processor to take corrective action responsive to results of at least one of the first and second scans of the storage device for malware.

10. The computer system of claim 9, wherein the storage device is a hard disk drive.

11. The computer system of claim 10, wherein the plurality of program instructions are configured to cause the at least one processor to prefetch the respective one or more portions of the files in the at least a subset of the plurality of files in an order that reduces seeks on the hard disk drive.

12. The computer system of claim 10, wherein, in reading from the storage device the one or more portions of the file requested by the anti-malware engine and prefetching into a buffer the one or more portions of the file requested for analysis by the anti-malware engine, the plurality of program instructions are configured to cause the at least one processor to perform direct disk access.

13. The computer system of claim 9, wherein, in taking corrective action, the plurality of program instructions are configured to cause the at least one processor to report the results to a user.

14. The computer system of claim 9, wherein, in taking corrective action, the plurality of program instructions are configured to cause the at least one processor to at least one of quarantine and remove malware detected on the storage device.

15. A computer-readable storage medium containing a plurality of program instructions executable by a processor for scanning a computer storage device for malware, the plurality of program instructions comprising:
a first instruction segment configured, for each file in the plurality of files during a first scan of the computer storage device to detect malware, to:
receive a request from an anti-malware engine for one or more portions of the file;
read from the computer storage device the one or more portions of the file requested by the anti-malware engine and to supply them to the anti-malware engine, the anti-malware engine analyzing the one or more portions of the file for malware; and
record which one or more portions of the file were requested for analysis by the anti-malware engine;
a second instruction segment configured, for each of at least a subset of the plurality of files during a second scan of the computer storage device to detect malware, to:
prefetch into a buffer the one or more portions of the file requested for analysis by the anti-malware engine during the first scan; and
supply to the anti-malware engine the prefetched one or more portions of the file as they are requested, the anti-malware engine analyzing the prefetched one or more portions of the file for malware; and
a third instruction segment configured to take corrective action responsive to results of at least one of the first and second scans of the computer storage device to detect malware.

16. The computer-readable storage medium of claim 15, wherein the computer storage device is a hard disk drive.

17. The computer-readable storage medium of claim 16, wherein the second instruction segment is configured to prefetch the respective one or more portions of the files in the at least a subset of the plurality of files in an order that reduces seeks on the hard disk drive.

18. The computer-readable storage medium of claim 16, wherein, in reading from the storage device the one or more portions of the file requested by the anti-malware engine and prefetching into a buffer the one or more portions of the file requested for analysis by the anti-malware engine, the first and second instruction segments are configured to perform direct disk access.

19. The computer-readable storage medium of claim 15, wherein, in taking corrective action, the third instruction segment is configured to report the results to a user.

20. The computer-readable storage medium of claim 15, wherein, in taking corrective action, the third instruction segment is configured to at least one of quarantine and remove malware detected on the computer storage device.
